(19) United States
(12) Patent Application Publication
(10) Pub. No.: US 2010/0277845 A1
(43) Pub. Date: Nov. 4, 2010

(54) Circuit Apparatus for Protecting a Pre-Charge Resistance Using an Interlock Switch

(75) Inventors: Sang Hyun Park, Daejeon (KR); Soo Yeup Jang, Daejeon (KR); Joong Hui Lee, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: SK ENERGY CO., LTD., Seoul (KR)

(21) Appl. No.: 12/811,789

(22) PCT Filed: Nov. 19, 2008
(86) PCT No.: PCT/KR08/06812

§ 371 Date: Jul. 6, 2010

(30) Foreign Application Priority Data
Jan. 7, 2008 (KR) 10-2008-0001551

(51) Int. Cl. H02H 3/00

(52) U.S. Cl. 361/87

(57) ABSTRACT

The present invention relates to a circuit apparatus for protecting a pre-charge resistance using an inter-lock switch, and more particularly, to a circuit apparatus for protecting a pre-charge resistance by controlling a current flowing to a voltage transformer of an electric vehicle using an inter-lock switch and a polyswitch. The present invention provides a circuit apparatus for protecting a pre-charge resistance using an inter-lock switch, including a pre-charge resistance, a pre-charge relay and a main relay placed between a battery of a hybrid electric vehicle and a voltage transformer, wherein the circuit apparatus includes an inter-lock switch which is operated complementarily with the pre-charge relay and is for preventing continuous flow of an overcurrent to the voltage transformer and the resulting damage of the pre-charge resistance.

### TECHNICAL FIELD

The present invention relates to a circuit apparatus for protecting a pre-charge resistance using an inter-lock switch, and more particularly, to a circuit apparatus for protecting a pre-charge resistance by controlling a current flowing to a voltage transformer of an electric vehicle using an inter-lock switch and a polyswitch.

### BACKGROUND ART

A motor vehicle includes many electric apparatuses such as lights, air conditioner and wiper that are operated by an electric current. These electric apparatuses are driven by power outputted from a battery of the motor vehicle. In general, there are relays and fuses between the electric apparatuses and the battery in order to prevent an overcurrent from flowing through the motor vehicle and the current is controlled by the relays and fuses.

However, the fuse is melted and disconnected to protect circuits when an overcurrent flows. And, the disconnection of the fuse is difficult to be detected in advance and occurs anytime and anywhere without previous warning. When the fuse is not used, a circuit device such as a resistance is damaged by the overcurrent.

As one of conventional solutions to solve the problem due to the overcurrent, Korean Patent Application No. 2003-0063820 (Sep. 15, 2003) discloses “Polyswitch for protecting overcurrent in motor vehicle”.

The above polyswitch is placed between a lead-in wire and a lead-out wire to cut off power from a power supply when a temperature of a coil is increased by an overload and allow supplying of the power from the power supply when a resistance is decreased as the temperature of the coil is dropped by the cutoff of the power. However, there is no disclose the use of the polyswitch for protecting a pre-charge resistance and the use of the polyswitch together with an inter-lock switch for cutting off continuous overcurrent flowing to a voltage transformer.

As another solution, Korean Patent Application No. 2005-0054175 (Feb. 21, 2005) discloses “Circuit apparatus for protection of motor control unit in motor vehicle”.

The above circuit apparatus is placed between a main battery and a motor control unit of an electric vehicle and driven by a pre-charge relay and a main relay provided therein to adjust a voltage of a DC link capacitor of the motor control unit to a level corresponding to a voltage of the main battery, thereby protecting the motor control unit, wherein the circuit apparatus is provided with a resistance device variable by a temperature for restricting an amount of current flowing to the motor control unit when the DC link capacitor is shorted, at a side of the pre-charge relay. The above circuit apparatus does not teach an inter-lock switch and a polyswitch for preventing an overcurrent from flowing to a voltage transformer.

FIG. 1 shows a circuit present between a battery and a voltage transformer of a hybrid electric vehicle. In the hybrid vehicle, it is important to ensure safety of the battery 110 with high voltage (300 to 400V). The battery 110 of the hybrid vehicle has a limited volume since it should be mounted in a motor vehicle. A capacity of a pre-charge resistance 120 against a continuous current is as follows.

When considering that a current of 10 A continuously flows through a resistance of 30Ω, the resistance must have the capacity resistible against P=I²R=3000 W. A currently used resistance has a resistance of 30Ω and a capacity of 60 W and thus can hardly resist when the current of 10 A continuously flows in.

In general, a resistance having a capacity of over 1000 W is difficult and high cost consumable to be manufacture and is also hard to be realized in a limited space. In a normal condition, there occurs no problem in the current system.

However, when a main (+) relay 150 is not closed for a certain period time after a pre-charge relay 140 is operated, an unallowable large continuous current flows through the pre-charge resistance 120 and the pre-charge resistance 120 may thus be damaged. The battery 110 for the hybrid vehicle includes a lithium battery, which has a risk of explosion by overheat. In other words, the damage of the pre-charge resistance may result in the risk of explosion of the battery system.

### DISCLOSURE

### Technical Problem

An object of the present invention is to provide a circuit apparatus for protecting a pre-charge resistance by using an inter-lock switch which prevents an overcurrent from flowing to a voltage transformer.

Also, an object of the present invention is to provide a circuit apparatus for protecting a pre-charge resistance by using a polyswitch which cuts off the overcurrent flowing through the pre-charge resistance as its resistance is increased with raise in the temperature when an overcurrent flows through the pre-charge resistance.

### Technical Solution

The present invention provides a circuit apparatus for protecting a pre-charge resistance using an inter-lock switch, including a pre-charge resistance, a pre-charge relay and a main relay placed between a battery of a hybrid electric vehicle and a voltage transformer, wherein the circuit apparatus includes an inter-lock switch which is operated complementarily with the pre-charge relay and is for preventing continuous flow of an overcurrent to the voltage transformer and the resulting damage of the pre-charge resistance.

The inter-lock switch is placed between a DC link capacitor and a low voltage DC-DC converter which are included in the voltage transformer.

The circuit apparatus may further includes a polyswitch which cuts off the overcurrent flowing through the pre-charge resistance as its temperature is raised and its resistance value is increased when the overcurrent flows continuously to the pre-charge resistance, and the polyswitch is placed between the pre-charge resistance and the pre-charge relay or between the battery of the hybrid electric vehicle and the pre-charge resistance.

### ADVANTAGEOUS EFFECTS

The circuit apparatus for protecting a pre-charge resistance using an inter-lock switch according to the present invention can protect efficiently the pre-charge resistance from an overcurrent by using the inter-lock switch which prevents the overcurrent from flowing to a voltage transformer.

Also, The circuit apparatus for protecting a pre-charge resistance using an inter-lock switch according to the present invention can protect efficiently the pre-charge resistance from the overcurrent by using the polyswitch which cuts off the overcurrent flowing through the pre-charge resistance as its resistance is increased with raise in the temperature, instead of using a fuse.

### DESCRIPTION OF DRAWINGS

The above and other objects, features and advantages of the present invention will become apparent from the following description of preferred embodiments given in conjunction with the accompanying drawings, in which:

FIG. 1 is a view illustrating a conventional circuit present between a battery and a voltage transformer of a hybrid electric vehicle.

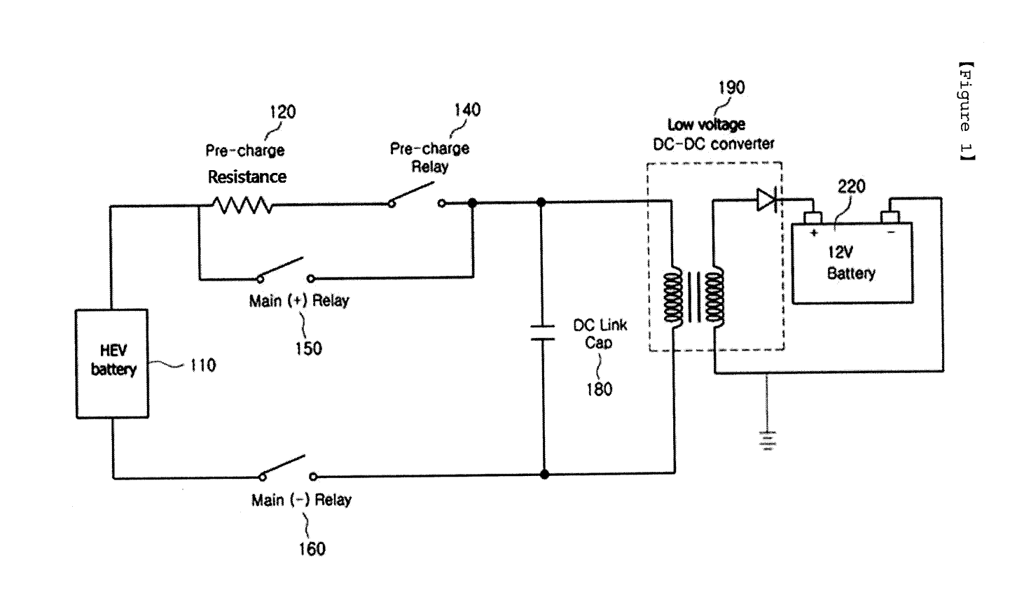

FIG. 2 is a view illustrating a circuit apparatus for protecting a pre-charge resistance using an inter-lock switch according to an embodiment of the present invention.

### DETAILED DESCRIPTION OF MAIN ELEMENTS

110: battery of hybrid electric vehicle
120: pre-charge resistance
130: polyswitch
140: pre-charge relay
150: main (+) relay
160: main (−) relay
170: inter-lock switch
180: DC link capacitor
190, 210: low voltage DC-DC converter
200: motor control unit
220: battery

### BEST MODE

Terms used herein are defined in consideration of functions in the present invention and can be changed according to the custom or intention of users or operators. Thus, definition of such terms should be determined according to overall disclosures set forth herein.

Hereinafter, the embodiments of the present invention will be described in detail with reference to accompanying drawings.

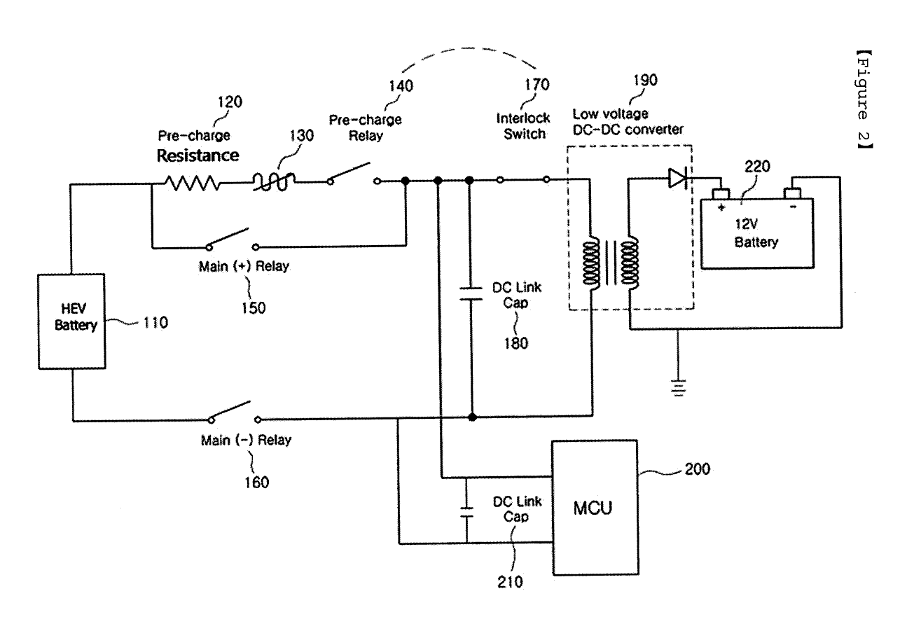

FIG. 2 is a view illustrating a circuit apparatus for protecting a pre-charge resistance using an inter-lock switch according to an embodiment of the present invention. Referring to FIG. 2, the circuit apparatus for protecting a pre-charge resistance includes a pre-charge resistance 120, a polyswitch 130, a pre-charge relay 140, a main (+) relay 150, a main (−) relay 160 and an inter-lock switch 170.

First, the pre-charge relay 140 and the main (−) relay are closed and a current flows through the pre-charge resistance, thereby charging a DC link capacitor 180 of a voltage transformer. The voltage transformer includes the DC link capacitor 180, a low voltage DC-DC converter 190 and a battery 220. Next, after the DC link capacitor 180 is charged to a certain extent, the main (+) relay is closed. Accordingly, the current does not flow through the pre-charge resistance 120 but flows only through the main (+) relay 150 and the main (−) relay 160.

In a case that a hybrid vehicle operates normally, it takes very short time to change over from the pre-charging operation to the operation of the main relays. However, when a large current flows continuously through a voltage transformer such as the low voltage DC-DC converter 190 or the DC link capacitor 180 is shorted before changed over to the operation of the main relays, the large current may flow continuously to the pre-charge resistance 120.

The circuit apparatus for protecting a pre-charge resistance prevents an overcurrent from flowing continuously using the inter-lock switch 170 placed between the DC link capacitor 180 and the low voltage DC-DC converter 190. The inter-lock switch 170 is operated complementarily with the pre-charge relay 140. That is to say, the inter-lock switch 170 is opened when the pre-charge relay 140 is closed and the inter-lock switch 170 is closed when the pre-charge relay 140 is opened. Therefore, even though a large current flows continuously through the low voltage DC-DC converter 190, the pre-charge relay 140 is opened when the inter-lock switch 170 is closed, thereby not allowing the current does to flow to the pre-charge resistance 120, and the current does not flow from the pre-charge protection circuit to the low voltage DC-DC converter 190 when the inter-lock switch 170 is closed, thereby not allowing the overcurrent to flow to the pre-charge resistance 120.

Also, the circuit apparatus for protecting a pre-charge resistance according to the present invention may protect the pre-charge resistance 120 only using the inter-lock switch 170 or may protect the pre-charge resistance 120 using the inter-lock switch 170 together with the polyswitch 130. The poly switch 130 interrupts the circuit as its resistance is sharply increased when its temperature is raised by heat. That is to say, when a certain overcurrent flows continuously through the pre-charge resistance 120 to raise the temperature of the pre-charge resistance 120, the resistance of the polyswitch 130 is sharply increased and the current does not flow through the pre-charge resistance 120 any more.

The polyswitch 130 may be placed between the pre-charge resistance 120 and the pre-charge relay 140 as shown in FIG. 2, or placed between the battery 110 of the hybrid electric vehicle and the pre-charge resistance 120. It is possible to charge the DC link capacitor 210 connected with the motor control unit 200 using the pre-charge relay 140, the main (+) relay 150 and the main (−) relay 160, but it is apart from the subject matter of the present invention and thus will not be described.

### INDUSTRIAL APPLICABILITY

Although the present invention has been described with reference to the embodiments shown in the drawings, it should be understood that these embodiments are provided for illustrative purpose and that various equivalent modifications and alterations will be apparent to those skilled in the art without departing from the scope and spirit of this invention.

1. A circuit apparatus for protecting a pre-charge resistance using an inter-lock switch, comprising a pre-charge resistance, a pre-charge relay and a main relay placed between a battery of a hybrid electric vehicle and a voltage transformer,
wherein the circuit apparatus further comprises an inter-lock switch which is operated complementarily with the pre-charge relay and is for preventing continuous flow of an overcurrent to the voltage transformer and the resulting damage of the pre-charge resistance.

2. The circuit apparatus for protecting a pre-charge resistance using an inter-lock switch as set forth in claim 1, wherein the inter-lock switch is placed between a DC link capacitor and a low voltage DC-DC converter which are included in the voltage transformer.

3. The circuit apparatus for protecting a pre-charge resistance using an inter-lock switch as set forth in claim 1, further comprising:
a polyswitch which cuts off the overcurrent flowing through the pre-charge resistance as its temperature is raised and its resistance value is increased when the overcurrent flows continuously to the pre-charge resistance.

4. The circuit apparatus for protecting a pre-charge resistance using an inter-lock switch as set forth in claim 3, wherein the polyswitch is placed between the pre-charge resistance and the pre-charge relay or between the battery of the hybrid electric vehicle and the pre-charge resistance.
